(19) United States
(12) Patent Application Publication
(10) Pub. No.: US 2008/0272896 A1
(43) Pub. Date: Nov. 6, 2008

(54) Object tracking method and apparatus

(76) Inventors: Maria Adamczyk, Alpharetta, GA (US); Edward Silver, Atlanta, GA (US)

Correspondence Address: MYERS BIGEL SIBLEY & SAJOVEC, P.A., P.O. BOX 37428, RALEIGH, NC, 27627, US

(21) Appl. No.: 11/799,338

(22) Filed: May 1, 2007

(51) Int. Cl. G08B 13/00

(52) U.S. Cl. 340/426.1; 340/568.1; 340/572.1

(57) ABSTRACT

A method of securing moving objects includes receiving signals from the moving objects, determining location of the moving objects based on the received signals, evaluating the location information and triggering an alarm notification if the evaluation results in determination that a moving object is located outside a permissible area.

### BACKGROUND

This invention relates generally to security systems and more particularly to methods and apparatus for tracking location of movable objects.

Devices for securing objects, including movable and non-movable objects, are known. Movable objects, such as automobiles, may be secured by locking doors to prevent access to the object. A power source for the automobile, such as a battery, may be disabled or removed to prevent an automobile from being moved without authorization. Alarms may be installed to provide a notification when an automobile is improperly accessed. Tracking devices such as a Lo-Jack® may also be installed in automobiles which emit a signal in response to being activated upon a determination being made that the automobile is stolen or removed without permission. The emitted signal can be used to locate the automobile.

There are disadvantages in particular environments to each of the devices described. It is inadvisable to lock doors and remove batteries of an automobile that is offered for sale as either a new or pre-owned automobile by an automobiles sales outlet. Alarms and Lo-Jack® devices typically are activated after an automobile has been accessed or removed at which point, it is too late to recover the automobile in an unaltered state. For example, an automobile may be damaged before alarm activation or after being stolen.

Given such disadvantages, it would be desirable to track the location of a movable object by less inconvenient methods. A transmitter module may be installed within the movable object to provide location information.

### SUMMARY

In one embodiment, a method for securing movable objects comprises receiving signals from the movable objects, determining location of the movable objects based on the received signals, evaluating the location information and triggering an alarm notification if the evaluation results in determination that a movable object is located outside a permissible area

In another embodiment, a monitoring station for securing movable objects comprises a receiver for receiving signals from a plurality of movable objects, a computer for determining location of the movable objects based on the received signals and an alarm, the alarm being activated when a location of at least one of the movable objects is determined to be outside a permitted area

In yet another embodiment, a computer-readable medium contains a computer program for securing movable objects. The computer program, when executed on a computing device, causes the computing device to receive signals from the movable objects, determine location of the movable objects based on the received signals, evaluate the location information and trigger an alarm notification if the evaluation results in determination that a movable object is located outside a permissible area.

### BRIEF DESCRIPTION OF THE DRAWINGS

The various features, advantages, and objects of the invention will be understood by reading this description in conjunction with the drawings, in which:

FIG. 1 illustrates an automobile sales lot;

FIG. 2 illustrates a central monitoring station; and

FIG. 3 illustrates an automobile location status table; and

FIG. 4 illustrates an exemplary method for tracking location of movable objects;

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

In general, exemplary embodiments describe tracking and determining location of movable objects such as automobiles displayed in an automobile sales lot. Specifically, a location and movement of a movable object may be monitored utilizing tracking devices or modules.

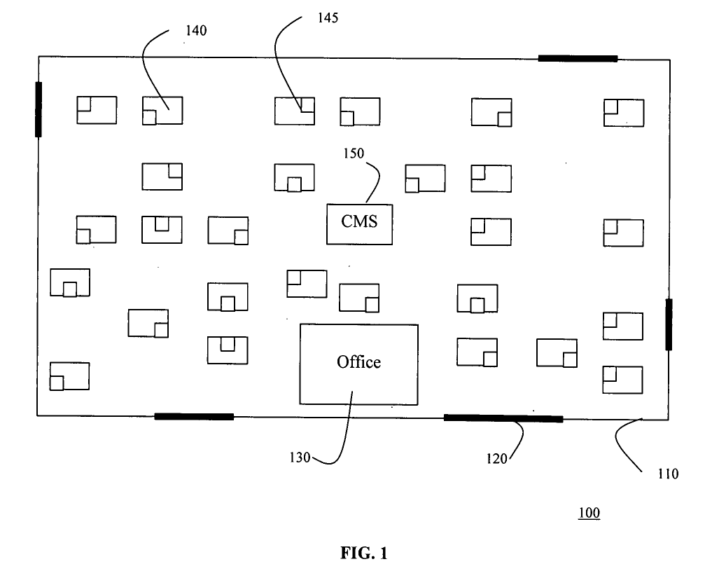

FIG. 1 illustrates an automobile sales lot 100. Automobile dealers typically store or display automobiles that are offered for sale in a location similar to sales lot 100. Sales lot 100 may be defined by a fence 110. Access to sales lot 100 (i.e. entry and exit) may be provided via gates or entryways 120. Sales lot 100 may also include an office 130. A plurality of automobiles 140 may be stored throughout sales lot 100 such as in the exemplary arrangement illustrated in FIG. 1. The arrangement may not be restricted to the illustrated embodiment—automobiles 140 may be located or scattered randomly within automobile sale lot 100.

Tracking modules may be installed in each of automobiles 140 to facilitate monitoring of the automobile location. The tracking modules may emit signals that can be detected within a predetermined range. The range may depend on the type of tracking module that is in use.

A tracking module may transmit a signal in one of many forms. The signal could be an electronic signal such as a radio frequency signal. One example of a tracking module using a radio frequency signal may be a radio frequency identification module (RFID). A cellular telephone may function as a tracking module as well.

The signal could be a sonic signal. The signal could be an optical signal. A signal from the tracking module could be in other forms as well. Any one of the types of tracking modules used herein may transmit a wireless signal and operate autonomously. Each of these types of tracking modules may require different amounts of power for transmission of the signal. The range of the signal may depend on the amount of power used for transmission.

A central monitoring station (CMS) 150 may detect or receive signals from tracking modules located within range. Central monitoring station 150 may be located within automobile sales lot 100. Tracking modules 145 may be installed within automobiles 140. In order to optimize the reception of signals from tracking modules 145, central monitoring station 150 may be located near the center of automobile sales lot 100. In some embodiments, a plurality of receiving stations may be included within sales lot 100. Signals received at each of these receiving stations may be relayed to the central monitoring station upon receipt or may be relayed at a predetermined frequency.

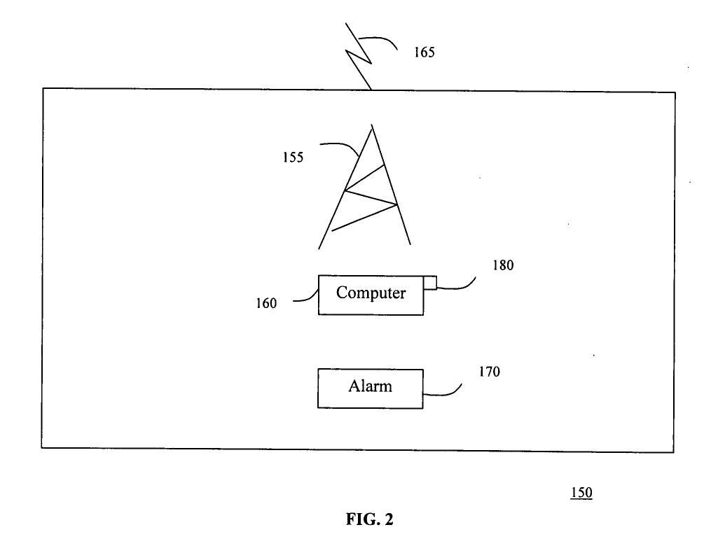

FIG. 2 illustrates an exemplary central monitoring station 150. Central monitoring station 150 may include a receiving component such as an antenna 155. Antenna 155 may receive signals 165 emitted from tracking modules 145.

Central monitoring station 150 may also include a computing device 160 for processing received signals 165 and for determining location of an automobile 140 based on the signal 165 from a particular automobile 140. Some tracking modules may have the ability to provide their geographic location in the transmitted signal. In some embodiments utilizing a plurality of receiving stations, the functional capability of the central monitoring station may be included in each or some of the plurality of receiving stations.

An indoor localization system that is economical and may be utilized is the Landmarc system. Landmarc is an indoor localization system using RFID technology which introduces the concept of reference tags to reduce the number of RFID readers.

In addition to determining location of an automobile 140, an alarm notification may be included in exemplary embodiments if an automobile 140 travels outside a designated safe or acceptable area or range. For example, if an automobile 140 is removed beyond automobile sales lot 100, an alarm 170 may be activated within central monitoring station 150. A boundary may be defined within which an automobile 140 may be moved without triggering an alarm.

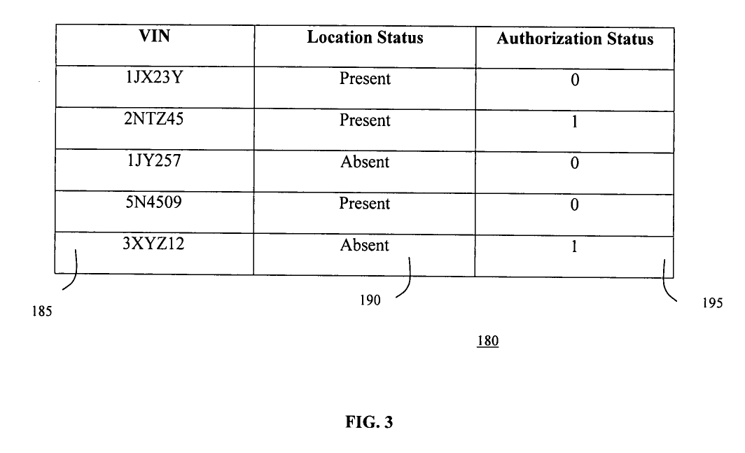

A status table may be maintained within computing device 160. As illustrated in FIG. 3, status table 180 may include columns 185, 190 and 195. Column 185 may represent identification of an automobile 140 such as a vehicle identification number (VIN). Column 190 may represent location status of automobile 140 based on signal 165 received from automobile 140.

Location value for column 190 may be a binary value such as “1” and “0”. A value of “1” may represent presence of an automobile 140 within automobile sales lot 100 or within the designated safe or acceptable area or range. A value of “0” may represent location of automobile 140 outside the automobile sales lot 100 or outside the designated safe or acceptable area or range. An alarm may be activated if the location value in column 190 of status table 180 is “0”.

Since automobiles may be taken on test drives which may result in the automobile being outside the designated acceptable area, status table 180 may include an additional column 195. Column 195 (authorization status) may indicate whether the movement is pre-authorized for example. That is, a salesperson or an authorized individual may indicate his intention to take a vehicle for a test drive. This information may be provided to computing device 160 prior to taking the vehicle outside the designated area. The value for column 195 may also be a binary. That is, the default value for column 195 may be a “0” which can be changed to a “1” if a vehicle is being taken for a test drive.

Location value for column 190 may also be represented by status “present” or “absent”. A “present” value may indicate that an automobile is within the acceptable range or is in a safe location (i.e. not considered to be stolen or have been moved without permission). An “absent” value may indicate that an automobile is outside the acceptable range or is not in a safe location.

An alarm activation may provide notification in one of many known methods. An audio signal may be triggered within office 130. A visual indication such as one or more flashing red lights may be triggered within office 130 or within automobile sales lot 100. The visual indication may be triggered in conjunction with a prompt on a computer terminal; the prompt may describe the automobile such as make, model, color, etc.

An alert may be prompted at a computer terminal being monitored by a security company or police. The alert may specify the VIN and the associated description such as make, model, color, etc.

A particular type of tracking modules mentioned above, RFIDs, may be one of two types. A first type of RFID may be an active RFID. An active RFID may transmit a signal at a predetermined interval such as at every two minutes for example.

A second type of RFID may be a passive RFID. A passive RFID may respond to a signal from the central monitoring station. That is, the central monitoring station may poll the passive RFID at a pre-determined frequency. This frequency may also be every two minutes for example although it can vary based on a number of factors such as for example, the size of the automobile sales lot and number of gates, etc. The operation of RFIDs is well known and will not be described in further detail.

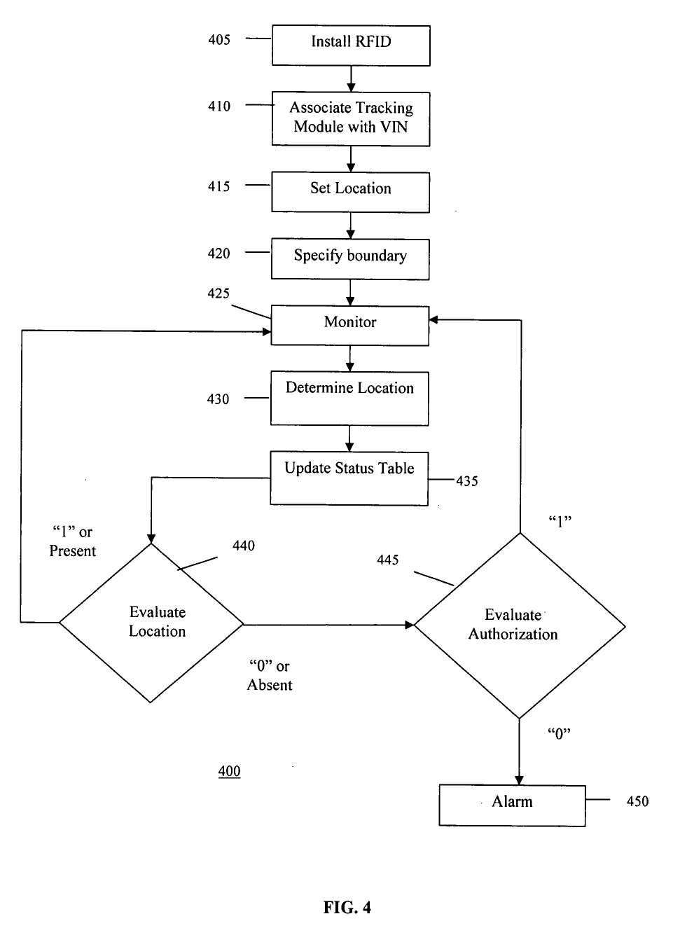

An exemplary method may be described with reference to the flow diagram or process 400 of FIG. 4. A tracking module 145 may be installed within each of automobiles 140 at 405. A vehicle identification number may be associated for each of the tracking modules (VIN) at 410 representing the automobile 140 in which the tracking module is installed.

A location of the automobile 140 may also be set at 415; that is, the initial location at which automobile 140 is parked may be set. The boundaries of usage for each or all of automobiles 140 may then be specified at 420. The boundary may be a distance from the initial location or a distance from central monitoring station 150 for example. In some embodiments, the boundaries of usage may be set to a location of gates 120. The location information for gates 120 may be pre-specified.

Upon setting up of the parameters, monitoring may take place at 425. Monitoring may consist of receiving tracking module signals 165 from tracking modules 145. As described above, active tracking modules transmit signals at a pre-determined frequency. Passive tracking modules, on the other hand, respond to polling signals from central monitoring station 150. In either case, the signals or responses from tracking modules may be received by the central monitoring station 150.

Based on the received signals, computing device 160 may compute or determine location of automobiles 140 at 430. In some embodiments, computing device 160 may also compute distance traveled from the initial location by automobiles 140. Status table 180 may be updated by computing device 160 at 435 based on determination of location or distance.

Location of an automobile 140 may be evaluated at 440. As described above, the location status value 190 of an automobile 140 indicates whether an automobile is within a permitted location or area. If the value of 190 indicates “1” or “present” for example, monitoring may continue at 425.

If, on the other hand, the value indicates “0” or “absent”, a determination may be made as to whether the vehicle is on a test drive. This determination may be made by checking the value in column 195 at 445. If the value in column 195 is a “1”, then the vehicle is determined to be on a test drive (i.e. authorized movement) and monitoring continues at 425. If the determination at 445 is one of non authorized movement (i.e. a value of “0”), then an alarm may be activated at 450.

The computing device 160 at central monitoring station 150 may be a general purpose computing device. It can be a personal computer such as a desktop computer or a laptop computer or any other type of computing device having a processor, a memory, an input means and an output means. It may be connected to a network via a communication means such as a modem. The computing device may communicate with a police station or with a security service company to report an automobile being moved outside the automobile sales lot 100 for example.

In some embodiments, if an automobile is moved by an authorized person to provide a test drive to a potential buyer or for other types of authorized use, the tracking module component of the particular automobile (i.e. the one that is being taken for a test drive) may be deactivated or, in the alternative, the entry for the particular automobile 140 may be deactivated in status table 180.

While the above description focuses on a vehicle, exemplary methods as describe may be equally applicable to all movable (as well as moving) objects.

Exemplary embodiments can be within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

It will also be appreciated that procedures described above are carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

It is emphasized that the terms “comprises” and “comprising”, when used in this application, specify the presence of stated features, integers, steps, or components and do not preclude the presence or addition of one or more other features, integers, steps, components, or groups thereof.

Thus, this invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of securing movable objects, said method comprising the steps of:
receiving signals from said movable objects;
determining location of the movable objects based on said received signals;
evaluating the location information; and
triggering an alarm notification if the evaluation results in determination that a movable object is located outside a permissible area.

2. The method of claim 1, wherein the movable object is an automobile.

3. The method of claim 2, wherein the automobile is equipped with a tracking module.

4. The method of claim 3, wherein the tracking module emits the signals.

5. The method of claim 4, wherein the signal emitted by the tracking module is an electronic signal.

6. The method of claim 4, wherein the signal emitted by the tracking module is a sonic signal.

7. The method of claim 4, wherein the signal emitted by the tracking module is an optical signal.

8. The method of claim 3, wherein the tracking module is a radio frequency identification (RFID) module.

9. The method of claim 8, wherein the RFID module is an active RFID module.

10. The method of claim 9, wherein the active RFID module transmits signals at a predetermined frequency.

11. The method of claim 10, wherein the transmitted signals are received by a central monitoring station.

12. The method of claim 8, wherein the RFID module is a passive RFID module.

13. The method of claim 12, wherein the passive RFID module responds to signals transmitted from a central monitoring station.

14. The method of claim 13, wherein the signals are transmitted from the central monitoring station at a predetermined frequency.

15. The method of claim 1, wherein the alarm notification is one of an audio signal and a visual signal.

16. A monitoring station for securing movable objects, the station comprising:
a receiver for receiving signals from a plurality of movable objects;
a computer for determining location of the movable objects based on the received signals;
an alarm, said alarm being activated when a location of at least one of said movable objects is determined to be outside a permitted area.

17. The monitoring station of claim 16, wherein the receiver is an antenna.

18. The monitoring station of claim 16, wherein the signals are received from a tracking module installed within the movable objects.

19. The monitoring station of claim 18, wherein the signals are received at a predetermined frequency.

20. The monitoring station of claim 16, wherein the signals are received in response to a signal emitted by a transmitter at the monitoring station.

21. The monitoring station of claim 16, wherein the computer comprises a status table containing location information for each of said movable objects.

22. The monitoring station of claim 16, wherein the movable object is an automobile.

23. The monitoring station of claim 22, wherein the location information is associated with a vehicle identification number (VIN) of the automobile.

24. The monitoring station of claim 23, wherein the status table is updated based on a latest received signals from the movable objects.

25. A computer-readable medium containing a computer program for securing movable objects, the computer program, when executed on a computing device, causes the computing device to:
receive signals from said movable objects;
determine location of the movable objects based on said received signals;
evaluate the location information; and
trigger an alarm notification if the evaluation results in determination that a movable object is located outside a permissible area.
